(19) United States
(12) Patent Application Publication
(10) Pub. No.: US 2004/0019656 A1
(43) Pub. Date: Jan. 29, 2004

(54) System and method for monitoring global network activity

(76) Inventors: Jeffrey C. Smith, Draper, UT (US); Robert S. Head, Sandy, UT (US); Kevin A. Plumb, Sandy, UT (US); John J. Moss, Sandy, UT (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/398,640

(22) PCT Filed: Oct. 4, 2001
(86) PCT No.: PCT/US01/31344

(51) Int. Cl. G06F 15/16

(52) U.S. Cl. 709/217

(57) ABSTRACT

Disclosed is a system and a method for monitoring a subject's activity on a global communications network such as the Internet (107). The system comprises a client monitoring module (110) and an enterprise server (102) accessible over the global communications network by the client monitoring module (110). The client monitoring module (110) is established in the Windows Socket Layer (417) of the operating system of the subject's digital computer (108). The enterprise (102) is provided with a database of content (104) available on the network and corresponding topical categories of the content. Artificial intelligence is also provided to categorize on-the-fly content which is not present in the database (104). The method involves a supervisor establishing (526) an account and providing (524) a usage policy for each subject. Subsequently, when a subject requests (612) content from the global communications network (107), a copy of the request is routed (616) over the global communications network (107) to the enterprise server (102). The enterprise server (102) then determines (640) the content type and transmits (644) a code with the content type back to the client station which either allows (622) or disallows (630) the receipt of the requested content according to the subject's usage policy. Reports are also generated (530) by the enterprise server and are periodically transmitted (530) to the supervisor summarizing content requests made by the relevant subjects.

### THE FIELD OF THE INVENTION

The invention relates to Internet content monitoring, and more specifically, to systems and methods involving remote content monitoring and authorization over global communications networks such as the Internet.

### THE RELEVANT ART

The Internet has become a mainstream resource tool, used pervasively at work, school, and home. Instant access can be had over the Internet to almost any imaginable topic. While having such a vast amount of knowledge at one's fingertips is a great asset, it also causes certain problems. For instance, it is alarming to many parents that their children may inadvertently visit a web page with offensive content. Businesses also may be concerned that their employees will become less productive due to personal “hobby” surfing. Accordingly, it has become necessary in many instances to supervise and monitor the content that is being viewed and downloaded from the Internet.

Internet Management (IM) is a term that refers to the technology used for tracking, monitoring, and managing one or more subjects' internet usage at different locations including work, school, and home. Internet management is becoming increasingly important, as the above-discussed problems are receiving closer scrutiny. For example, legislative mandates are now requiring that technology be used to protect workers from offensive materials. Other considerations include increasing demand for IM solutions in small network and single-user environments and wide spread investment in Internet connectivity and growth of the user base.

Certain solutions have been offered for filtering and blocking inappropriate use of the Internet. These solutions include local filtering/blocking software, Internet Service Provider (ISP) based filtering, and in-house monitoring software. Filter/blocking software generally operates on the principle of user-defined allowable content and typically contains large lists of words that are or are not allowable or otherwise define content that is desired to be blocked. ISP based filtering often utilizes block-lists similar to filter/blocking software to block certain web pages at the ISP. In-house monitoring refers to the system of a person monitoring, reviewing, and authorizing questionable content.

Prior art IM systems suffer from several drawbacks. For instance, products that use block-lists are outdated quickly and are easily defeated. With over 200 million web pages (URLs) and thousands more being added every day, block list subscription services by themselves are inadequate. Another shortcoming in the block/filter method is the inability to assess the content of a web page. For example, one of the words on a block-list may be “breast.” The block/filtering software would block all pages containing that word. While this may be desirable in most cases, such software has also been found to block desirable content concerning, for instance, breast cancer. In-house monitoring is likely the most effective of the present alternatives, but is expensive, and lacks the ability to be scalable to the size of the enterprise, as a person must personally review all content, or at least all questionable content.

From the above discussion, it should be readily apparent that solutions for improving IM systems are needed. Among these solutions, more reliable content recognition would be a great improvement in the art. Additionally, the ability to monitor usage from a remote site would also be helpful. Particularly helpful would be a scalable capacity to track and record Internet content requests with the ability to authorize, in real time, web pages according their content and a subject's selected privileges.

### OBJECTS AND BRIEF SUMMARY OF THE INVENTION

The remote monitoring system and method of the present invention have been developed in response to the present state of the art, and in particular, in response to the problems and needs in the art that have not yet been fully solved by currently available Internet monitoring systems. Accordingly, it is an overall object of the present invention to provide a system and method that overcome many or all of the above-discussed shortcomings in the art. These and other objects, features, and advantages of the present invention will become more fully apparent from the following description and appended claims, or may be learned by the practice of the invention as set forth hereinafter.

In certain disclosed embodiments, the system of the present invention comprises a central enterprise server configured to remotely capture inbound and outbound Internet requests, a client monitoring module configured to communicate with the enterprise server, and a supervisor module configured to receive network usage data from the central server. Within the client monitoring module is found a server interface module configured to communicate with the central server over a global communications network such as the Internet. Preferably, notices of requests for content are forwarded from the client monitoring module to the enterprise server. Under the preferred embodiment of the present invention, a report management module located within the supervisor module is configured to receive reports from the central server. The reports comprise compilations of requests by users for content to be transmitted over the global communications network.

Also preferably provided within the enterprise server is an enterprise database containing a listing of content files and/or sites which content files can be located. The content files or sites are preferably accompanied by an annotation of the type of the content. That is, the content is preferably classified within one or more topical categories. Thus, when the server receives a notice of a request for content, the requested content may be compared to a corresponding listing within the enterprise database so that the type of the content can be determined. Also preferably within the server is a content review module configured to determine the nature of the subject matter of the requested content when the requested content is not listed within the Enterprise database. In one embodiment, the content review module is configured to analyze the entire body of the content and categorize the content on-the-fly.

Also under a preferred embodiment of the present invention, the central server is configured to contain a user profile database configured to allow the supervisor to set and adjust user profiles, a client interface module configured to transmit digital data to the user, and a supervisor interface module configured to transmit digital data to the client supervisor. The central server also preferably comprises a report generation module configured to generate and transmit reports to the supervisor both automatically and upon request.

Also preferably included is a client authorization module configured to transmit an authorization code to the client module. The client monitoring module may comprise a local database configured to contain listings and ratings of content previously requested.

A method of distributed network monitoring is also provided as part of the present invention. The method comprises providing a distributed network monitoring system, preferably configured in the manner previously described. In one embodiment the method also comprises installing the client monitoring module within a client computer and monitoring client activities over a global communications network. Under a preferred embodiment of the present invention, the method also comprises remotely the network activities of a client and forwarding notice of those activities to the enterprise server.

The method further comprises determining the nature of the subject matter of the network content request and categorizing the network content request. The subject matter type is then compared against the user's established set of privileges to determine whether or not to authorize to user to receive the requested content. An authorization code is then transmitted back to the client monitoring module directing the client monitoring module whether or not to give the user access to the requested content. In one embodiment, the method also comprises generating network usage reports and providing the reports to a supervisor.

The enterprise database is in one embodiment initially populated with data from a commercial categorization server. The database is frequently updated, including receiving updates from the content review program.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram illustrating one embodiment of a remote monitoring system of the present invention.

FIG. 2 is a schematic block diagram illustrating on embodiment of a central server of the present invention.

FIG. 3a is a schematic block diagram illustrating on embodiment of a supervisor module of the present invention.

FIG. 3b is a schematic block diagram illustrating on embodiment of a client module of the present invention.

FIG. 4 is a schematic block diagram illustrating one embodiment of the configuration of the remote monitoring system of the present invention.

FIG. 5 is a schematic flow chart diagram illustrating one embodiment of a method for remote monitoring of a client of the present invention.

FIG. 6 is a schematic flow chart diagram illustrating one embodiment of a method for conducting a client monitoring step of FIG. 5.

### DETAILED DESCRIPTION OF THE PREFERRED EMBODIMENTS

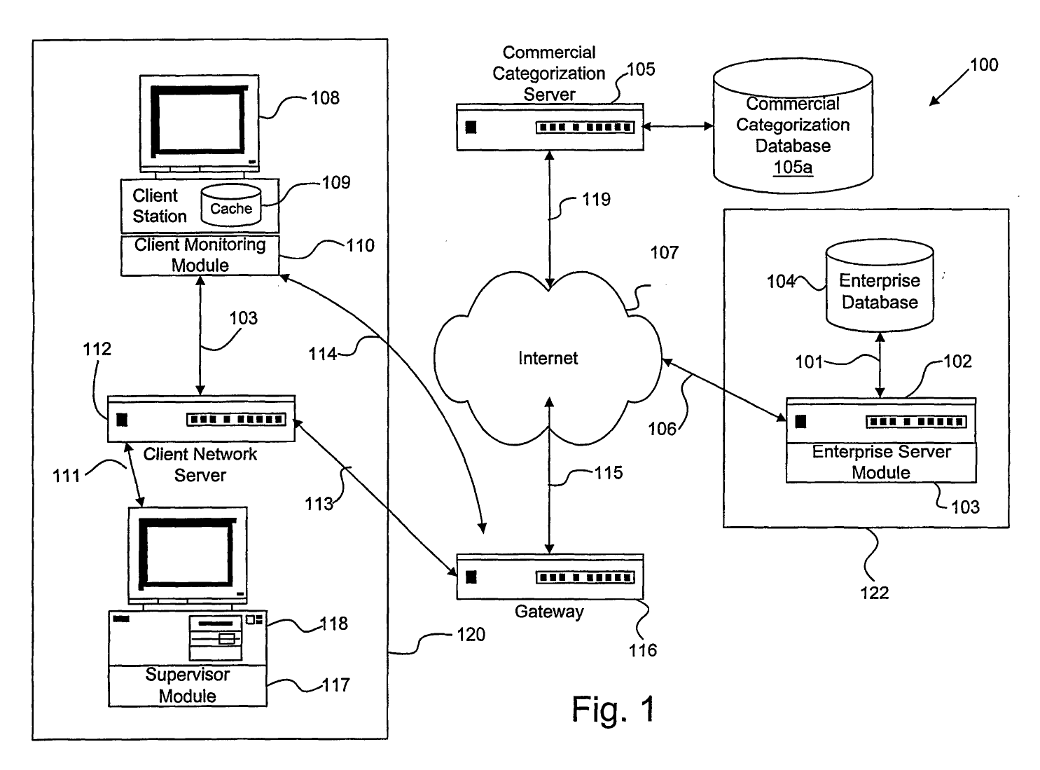

Shown in FIG. 1 is a remote monitoring system 100 of the present invention. The system 100 is capable of monitoring a subject's Internet usage remotely across the a global communications network such as the Internet. In one embodiment, notice of network content requested by the subject is passed to a remote enterprise server which preferably consults a local database for information about the nature of the content requested. If the Internet site from which the content is requested is not in the database, content monitoring software is used to determine the nature of the requested content. The type of the content is compared to the subject's selected privileges. A message is then transmitted back, allowing or disallowing the requested content to be received by the subject. Records of the subject's activity on the network is compiled and reports are periodically transmitted to a supervisor responsible for the subject.

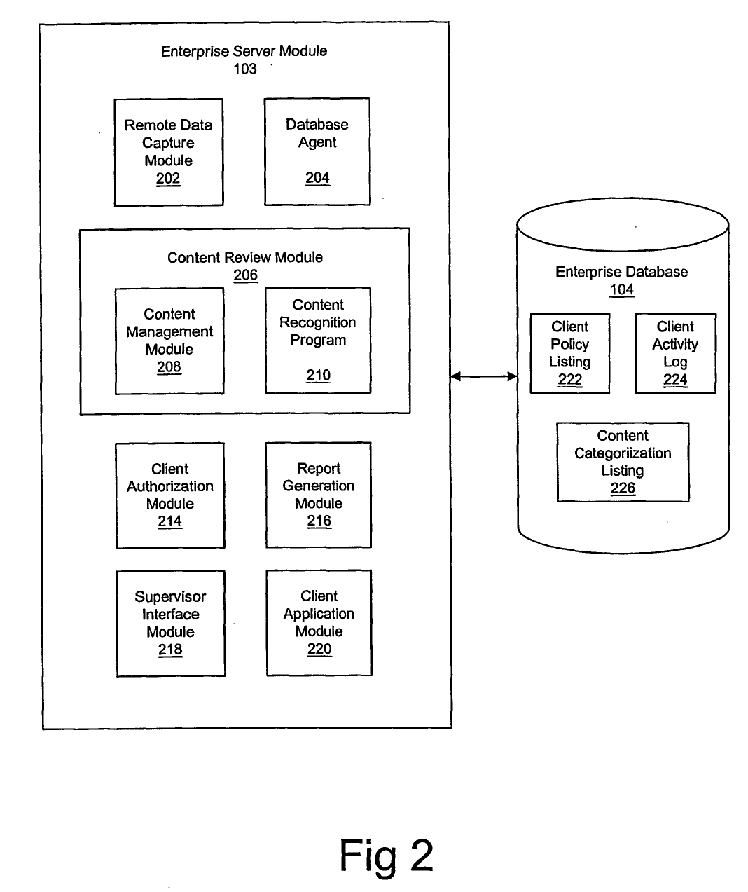

As shown, the system 100 is distributed across a global communications network 107. In one embodiment to be described hereafter, the global communications network 107 comprises the Internet. Within the system 100 is shown an enterprise server 102 having an enterprise server module 103. The configuration of the enterprise server module 103 is discussed in greater below with respect to FIG. 2. In one embodiment, the enterprise server 102 is configured to access an enterprise database 104 over a communication channel 101. The enterprise server 102 and the enterprise database 104 are preferably located at a common enterprise site 122 and may operate upon a common server computer.

Under a preferred embodiment of the present invention, the enterprise database 104 is initially populated with data from a remote commercial categorization server 105. In one embodiment, the data comprises the addresses of global network sites and corresponding topical categories to which the content of the Internet sites correspond. In one embodiment, the commercial categorization database comprises Rulespace® available from Rulespace Inc. located at Portland, Oreg.

The enterprise database 104 more preferably contains data regarding Internet content. For example, the enterprise database 104 may contain a list of universal resource locators (URLs) of web sites and the categories to which the contents of the web sites pertain. In one embodiment, the categories comprise subject matter topics such as pornography, hate, violence, hobby, day trading, and the like. Additionally, content may also be categorized into business and non business categories, and indeed, any useful categories may be employed.

The Enterprise server 102 is shown communicating with the global communications network (Internet 107) over a communications channel 106. In one embodiment, the communications channel is a digital data network configured to access the Internet 107. Under a preferred embodiment of the present invention, the enterprise site 122 comprises a central administration facility providing services to a plurality of clients.

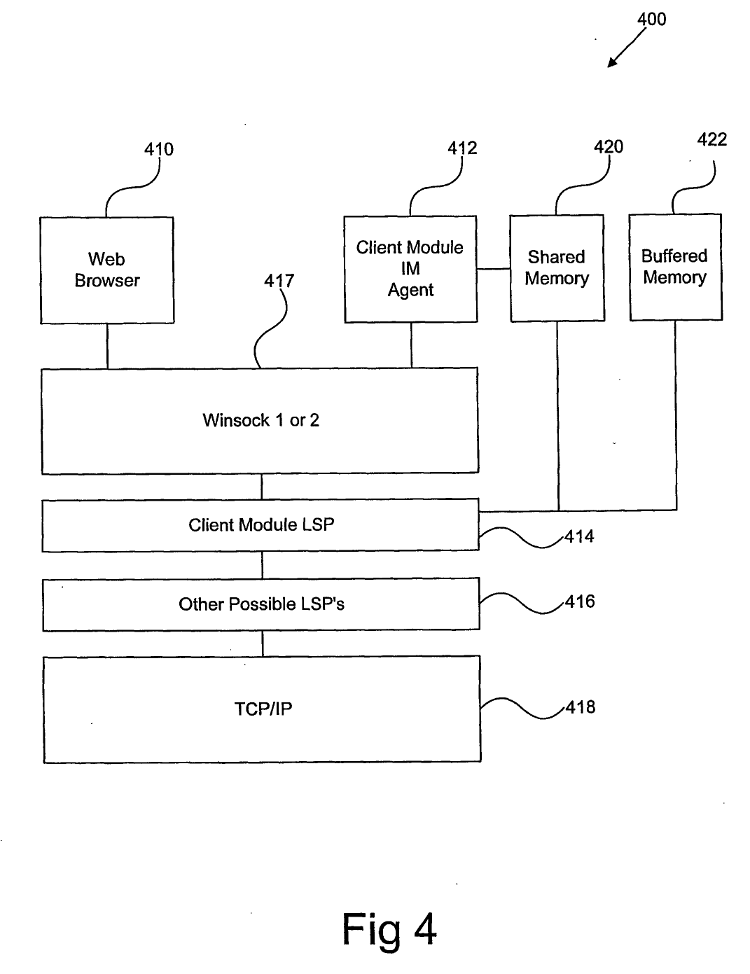

Also included in the depicted embodiment of the system 100 is a client site 120. As depicted, the client site 120 contains a client station 108, a client network server 112, and a supervisor station 118. The client station 108 may be the digital computer of a subject located at a place of work, an institution of learning, or a place of residence. Shown located within the client station 108 are a client cache 109 and a client monitoring module 110, the configuration of which will be explained in greater detail below with reference to FIG. 4b.

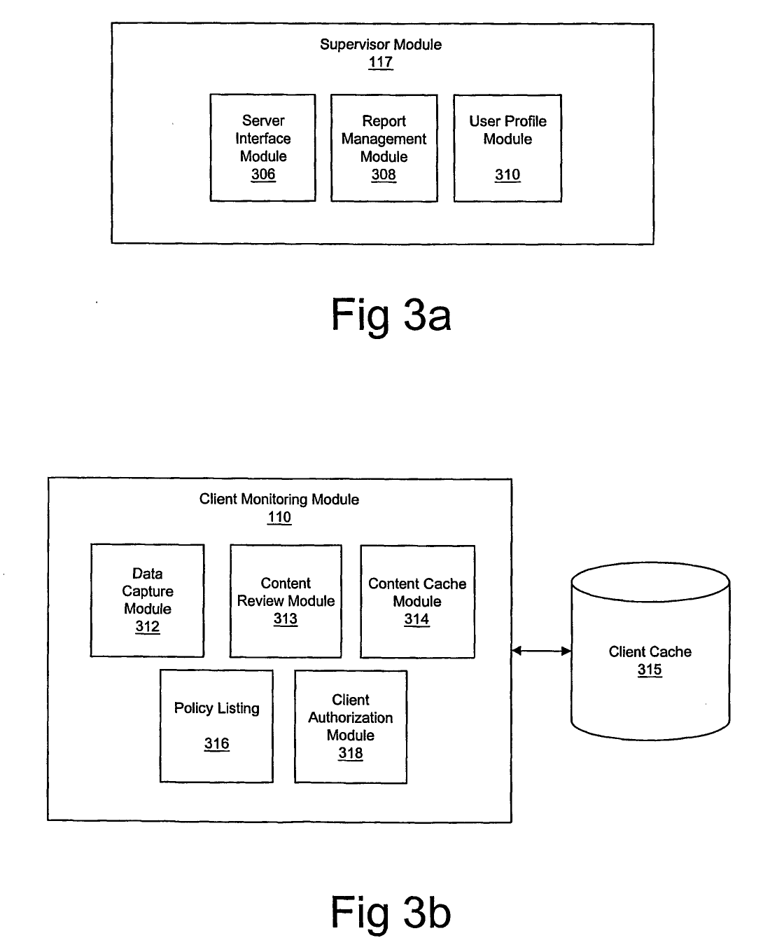

Under a preferred embodiment of the present invention, the client station 108 is provided with a client monitoring module 110 which shall be described in greater detail with respect to FIG. 3b. The client station 108 preferably connects to the Internet 107 through the client network server 112 and an Internet gateway 116. Alternatively, the client station 108 may connect directly to the Internet gateway 116 through a communication channel 114.

Under a preferred embodiment of the present invention, a supervisor module 117 is located within the supervisor station 118. The supervisor module 117 will be described below with respect to FIG. 3a. In one embodiment, the supervisor station 118 is the digital computer of a supervisor employee located at a place of work, an institution of learning, or a place of residence. Alternatively, the supervisor module 117 and the client monitoring module 110 may be located on a common computer or network 120. For example, the supervisor module 117 may be a password encoded program residing on a computer utilized by both a parent and a child. The client station 108 and the supervisor station 118 may also be distributed across a global communications network 107 and may be configured to interface remotely. For example, the supervisor may monitor the network usage of a user from any location in the world providing the supervisor has access to the Internet 107 or to another communication channel capable of communicating with the enterprise site 122.

Of course the various communication channels 101, 103, 106, 111, 113, 115, and 119 of FIG. 1 could comprise any suitable communication mediums or combination of communication mediums, including, networks, modems, and leased land lines.

Referring now to FIG. 2, shown therein is one embodiment of the basic functional components operating within the enterprise server 102 of FIG. 1. Under a preferred embodiment of the present invention, the enterprise server module 103 comprises a remote data capture module 202, a database agent 204, a content review module 206, a client authorization module 214, a report generation module 216, a supervisor interface module 218, and a client application module 220. The content review module 206 is shown comprised of a content management module 208 and a content recognition software program 210 such as the Contexion® program available from Rulespace Inc., located at Portland, Oreg.

The enterprise database 104 is shown containing a client policy listing 222, a client activity log 224, and a content categorization listing 226.

In one embodiment, the remote data capture module 202 is configured to receive notification of all requests for global communications content from the client station 108. The global communications content may comprise, for example, multimedia content, images, web content, email, chat room dialog, and newsgroups. The notification of the requests may comprise, for example, the transmission of a copy of the URL of the web page where the content is located.

When the notification is received, the database agent 204 confers with the enterprise database 104 to determine if the requested content is listed within the content categorization listing 226. If so, the category or categories to which the requested content pertains is noted, and passed to the client authorization module 214. In one embodiment, if the URL or other identifier of the requested content is not within the enterprise database 104, the content review module 206 is used to determine the nature of the content in substantially real time. Of course, other outside sources, such as an on-line version of the commercial categorization database 105a may also be consulted.

Under a preferred embodiment of the present invention, the content review module 206 is configured to obtain a copy of the requested content through the content management module 208. The requested content is then passed through the content recognition program 210 in real time. In one embodiment, the content recognition program 210 is configured to utilize a form of artificial intelligence to review the complete web site or other content and categorize the content almost immediately, preferably within milliseconds.

The content management module 208 then receives the results of the analysis of the content recognition program 210 and determines which categories are involved. Those categories are passed to the client authorization module 214. The client authorization module 214 receives the determined category(ies), whether from the database agent 204 or the content review module 206, and compares them against the client's privileges, as listed within the client policy listing 222. If the requested content is determined to violate the subject's established policy, the client authorization module 214 informs the client monitoring module 110 (of FIG. 1) to block the unauthorized content. If the content is within the allowable categories of the policy, the client authorization module 214 notifies the client monitoring module 110 to allow the subject to receive the requested content.

The content review module 206 is also preferably configured, through the content management module 208, to transmit the results of the analysis of the requested content to the enterprise database 104 for placement within the content categorization listing 226. The enterprise database 104 is thus frequently updated from the content review module 206, and may also be updated periodically from the commercial categorization server 105 of FIG. 1.

The report generation module 216 preferably records any violation to a client activity log 224. A violation may comprise, for example, a request for unauthorized content such as pornographic web content, personal hobby web content, and vulgar language in emails and chat rooms.

The report generation module 216 is also configured to create reports that may be sent to the supervisor of the client. Under a preferred embodiment of the present invention the supervisor interface module 218 is configured to allow the supervisor to alter the client policy 222 or to request a report of captured data from the report generation module 212. The client policy application module 220 is preferably configured to create a client policy listing 222 and to communicate with a client policy listing 222. One example of a client policy listing 222 may comprise a listing of allowable content, categories to be blocked, number of clients, client data and passwords, and billing information.

Referring now to FIG. 3a, illustrated therein is one embodiment of the supervisor module 117 of Figure of FIG. 1. Under the preferred embodiment of the present invention, the supervisor module 117 comprises a server interface module 306, a report management module 308, and a user profile module 310. The server interface module 306 is preferably configured to communicate with the enterprise server 102 of FIG. 1 over the Internet 107 or another such global communications network.

Utilizing the server interface module 306, the report management module 308 receives client reports generated by the report generation module 216 of FIG. 2. The client reports are preferably generated periodically, for example, weekly or monthly. Customized reports may also be requested by the supervisor utilizing the report management module 308, and may be configurable in a customer specified manner. In one embodiment, the user profile module 310 permits the supervisor to establish and modify the client policy listing 222 located in the enterprise database 104.

FIG. 3b is a schematic block diagram illustrating one embodiment of a client module 110 of FIG. 1. Under the preferred embodiment of the present invention, the client module 110 comprises a data capture module 312, a content review module 313, a content cache module 314, a blocking rules module 316, and a client authorization module 318. A client cache 315 is also depicted, and is preferably used to store a listing of previously requested content together with its corresponding categories.

The data capture module 312 is preferably configured to capture inbound and outbound network traffic and to transmit notice of all requests for network content to the central server 102. Outgoing communications may similarly be transmitted. The content review module 313 is an optional component that may replace the content review module 206 of FIG. 2 and is preferably configured in substantially the same manner as the content review module 206 of FIG. 2.

In one embodiment, the content cache module 314 compares the requested content against content data contained in the client cache module 315. If a listing of the requested content is present in the client cache 415, the category of the requested content is passed to the client authorization module 318, which compares the category against a policy listing 316 listing the subject's privileges. If the content is allowable, the client authorization module 318 allows the content to be received by the subject On the other hand, if the content is not within the set of privileges defined by for the user by a supervisor, the client authorization module 318 blocks the content and a report of the violation is transmitted to the central server 102 for compilation and later transmission to the supervisor module 117 of FIG. 1.

The central server also preferably reviews the requested content in the manner described above. Accordingly, if the requested content is not present within the client cache 315, the client authorization module 318 waits for notification from the client authorization module 220 of FIG. 2 whether the subject can be allowed to receive the requested content.

Referring now to FIG. 4, shown therein is a schematic block diagram illustrating one manner of implementing the client monitoring module 110. Under a preferred embodiment of the present invention, the system 400 illustrates the basic architecture and placement of the client monitoring module 110 within the client station 108. In FIG. 4, the client monitoring module 110, is placed within a client module LSP and is located below the winsock 1 0r 2 layer 417.

Like all network applications, the client monitoring module 110 utilizes the Microsoft Windows Winsock 417 to communicate with the global communications network 107 of FIG. 1. The web browser 410 is an example of an application operating within a client station 108. The web browser 410 implements the Winsock 417 to communicate with the global communications network 108. Alternatively, the web browser 410 may be any application that accesses the global communications network 107. The client module layered service provider 414 (LSP) installs immediately below the Winsock 417 and above other possible LSP's 416 which may be present on the client station 108. All network content requests made by other possible LSP's 416 below the client module LSP 414 must pass through the client module LSP 414. The TCP/IP layer 418 provides final communications with the network.

In one embodiment, the client monitoring module 110 is activated whenever any network traffic is detected in the client module LSP 414. A client may attempt to disable the client monitoring module 110, but upon the detection of a network content request the client module LSP 414 will re-activate the client monitoring module 110 through the shared memory region 420. The buffered memory 422 region is utilized by the client module LSP 414 to enhance network performance by allowing the network request to load into the client station 108 while the content is validated.

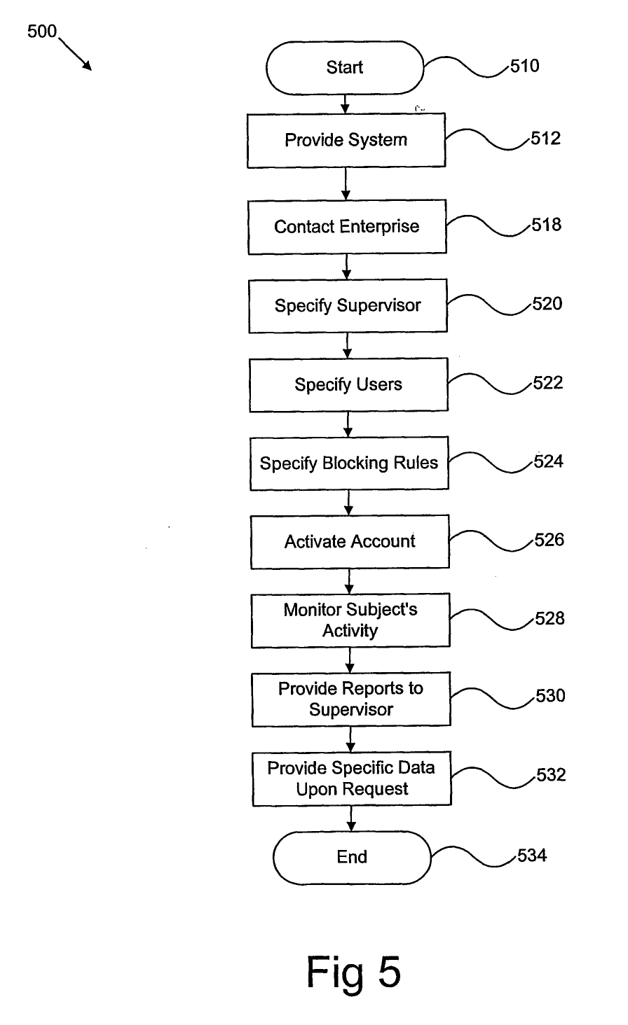

Referring now to FIG. 5, shown therein is one embodiment of a method 500 for remotely monitoring a subject's usage over a global communications network. The method of FIG. 5 starts 510, after which the remote monitoring system is provided 512. Under a preferred embodiment of the present invention the remote monitoring system is configured in substantially the same manner as described above for the system 100 of FIG. 1. In one embodiment, a customer contacts 518 the enterprise by telephone or by automated forms on the Internet. The customer specifies 520 the supervisor and also preferably specifies 522 the amount and identity of the users.

The customer then specifies 524 the set of blocking rules to be used for each user. The blocking rules may be common for all the users or customizable individually for each user. Under a preferred embodiment of the present invention, the blocking rules (or privileges) establish the types of content that a user may be allowed to download and/or view. Preferably, the supervisor enters the particular types of content (privileges) that each user at the client site 120 is allowed.

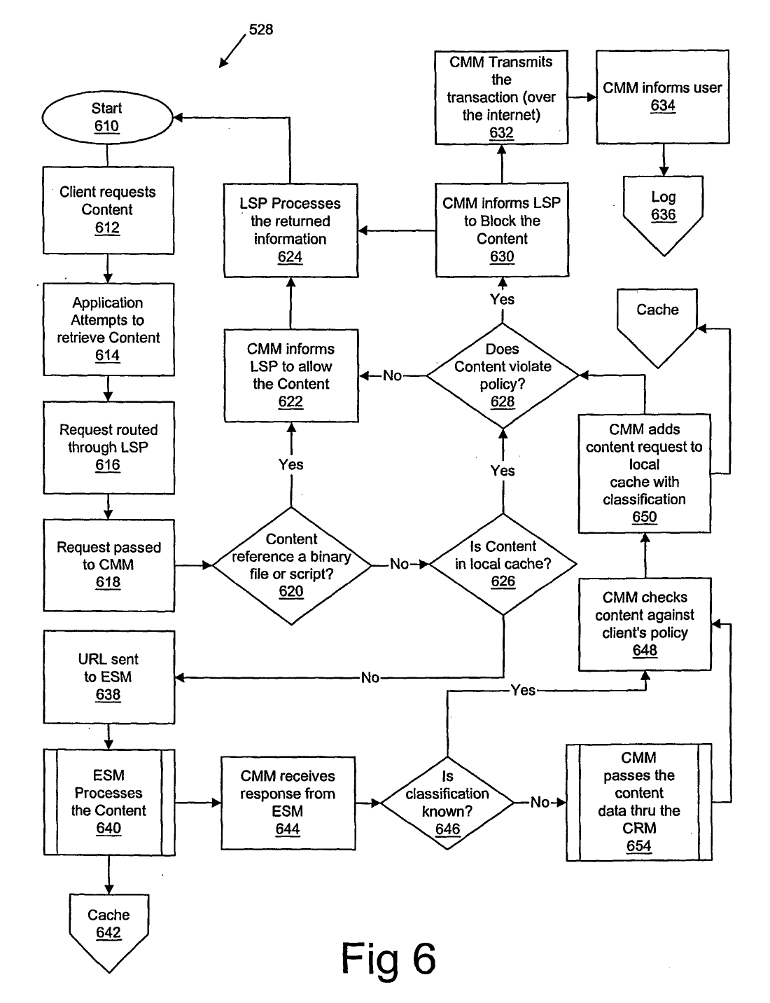

The customer then activates 526 the account. The network activity of each specified subject (or user) is then monitored 528, one manner of which will be described by way of example in greater detail below with reference to FIG. 6. Reports are provided 530 at periodic intervals to the supervisor. In one embodiment, the supervisor may also request 532 reports or specific data, and the reports may be custom-generated based upon the supervisor's requests. The method 500 ends at a step 534.

Referring now to FIG. 6, shown therein is a schematic flow-chart diagram depicting one embodiment of a method for monitoring a subjects activities over a global communications network. The method starts 610, after which a user requests the transmission of content over the network 612 using an application such as an E-mail client, a newsgroup reader, or a web browser. The desired application then attempts to retrieve 614 the requested content. The request for content is captured, in one embodiment by the client module LSP 414 of FIG. 4. Notice of the request is routed 616 through the client monitoring module 10, which in one embodiment is at least partially located within the client module LSP (CMLSP) 414 of FIG. 4. The client monitoring module 110 then determines whether the requested content references 620 a binary file or script which generally do not contain objectionable content. If so, the CMM 412 informs the CMLSP 414 that the requested content may be allowed 622. The CMLSP 414 processes 624 the information and the method 528 returns to the start 610.

If the result of the determination at step 620 is that the content does not reference a binary file or script, the content is compared to the local cache (e.g., the client cache 515). If the content 626 has previously been recognized and the type stored in the local cache, the content is checked 628 for violations. If the content violates 628 the client's privileges, the CMM 412 informs 630 the CMLSP 414 to block the content. The CMM 414 then transmits 632 the request to the central server 102. The CMM 414 also preferably informs 634 the user of the unallowable content and proceeds to log 636 the content in the local cache. The method then proceeds to block 624. If the determination at step 628 is that the content does not violate the client policy, then the method 528 follows block 622 to completion.

If the result of the determination at step 626 is that the content is not in the local cache, then the CMM 414 transmits 638 the content request to the enterprise server module (ESM) 103 of FIG. 2. The ESM 103 then proceeds to process 640 the context of the content request. At this point, the ESM 103 records 642 the category of the content request. The ESM 103 transmits 644 the classification to the CMM 412. If the classification is known 646, the CMM 412 compares 648 the classification against the client's privileges. The CMM then adds 650 the content request to the local cache along with the content request classification. The method 528 then follows block 628 to completion as described above.

If the result of the determination at block 646 is that the classification is not known, the CMM passes 654 the content request through the content review module CRM. The method 528 then follows block 648 to completion as described above.

The present invention is claimed and described herein in terms of “modules.” As used herein, this term is used to refer to software code instructions or to electronic hardware configured to achieve the given purpose of the module. As such, a module is a structural element. As will be readily understood to one skilled in the art of software development, more than one instruction may exist within a module. The instructions may not necessarily be located contiguously, and could be spread out among various different portions of one or more software programs, including within different objects, routines, functions, and the like. Similarly, the hardware components of a module, such as integrated circuits, logic gates, discrete devices, and the like, need not be organized into a single circuit, but could be distributed among one or more circuits. Unless stated otherwise, hardware or software implementations may be used interchangeably to achieve the structure and function of the disclosed modules. Thus, while the software modules contained in the schematic block diagrams of FIGS. 2, 3a, 3b, 4a, and 4b are generally implemented as software instructions, procedures, routines, or other executable software code, the modules may also be implemented with other types of programmable logic such as programmable logic arrays (PLAs), ASICs, logic circuits or discrete electric components.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for distributed monitoring of a subject's activities over a global communications network, the system comprising:
an enterprise server configured to receive notice of requests made by a user for content available on a global communications network; and
a client monitoring module configured to intercept the user requests, to forward notice of the user requests to the enterprise server, and to selectively allow the content requested by the user to be received by the user.

2. The system of claim 1, wherein the enterprise server is further configured to determine the type of the content requested by the user.

3. The system of claim 1, wherein the enterprise server is further configured to notify the client monitoring module of the type of the content requested by the user.

4. The system of claim 2, wherein the enterprise server is further configured to compare the type of the content requested by the user against a policy containing the user's privileges for viewing global communications network content.

5. The system of claim 2, wherein the enterprise server is further configured to notify the client monitoring module whether to allow the content requested by the user to be received by the user.

6. The system of claim 4, wherein the enterprise server is further configured to notify the client monitoring module whether to allow the content requested by the user to be received by the user.

7. The system of claim 2, further comprising an enterprise database containing a listing of content available on the global communications network and corresponding topical categories of the content, and wherein the enterprise server is configured to confer with the enterprise database in determining the type of the content requested by the user.

8. The system of claim 7, further comprising an artificial intelligence program within the enterprise server, the artificial intelligence program configured to examine requested content and to determine the nature of the requested content, and wherein the enterprise server is further configured to utilize the artificial intelligence program in determining the type of the content requested by the user when the requested content is not present in the enterprise database.

9. The system ofclaim 1, wherein the enterprise server is further configured to compile information regarding the requests made by a user for content available on a global communications network and to periodically transmit the information to a supervisor module.

10. The system of claim 1, further comprising an artificial intelligence program local to the client monitoring module, the artificial intelligence program configured to examine requested content and to determine the nature of the requested content, and wherein the client monitoring module is further configured to utilize the artificial intelligence program in determining the type of the content requested by the user in order to determine whether to allow the content requested by the user to be received by the user.

11. The system of claim 1, further comprising a report generation module local to the enterprise server, the report generation module configured to generate and transmit reports to the supervisor both automatically and upon request.

12. The system of claim 1, wherein the enterprise server is further configured with a policy database containing a policy for each user that defines the user's privileges for receiving selected types of content of the global communications network.

13. The system of claim 1, further comprising a content request module within the client monitoring module, the content request module configured to intercept all requests for content of the global communications network and to route a copy of the requests to the enterprise server.

14. The system of claim 1, further comprising a content caching module local to the client monitoring module, the content caching module configured to record the topical categories of previously requested content, and wherein the client monitoring module is further configured to consult the caching module to determine if content requested by a user is present within the content caching module, and if the content is present, dispense with forwarding notice of the user requests to the enterprise server.

15. The system of claim 7, further comprising a commercial categorization server, and wherein the enterprise database is initially populated by data from the commercial categorization server.

16. A system for distributed monitoring of a subject's activities over a global communications network, the system comprising:
an enterprise server;
a client monitoring module configured to intercept requests made by a user for content available on a global communications network, to forward notice of the user requests to the enterprise server, and to selectively allow the requested content to be received by the user;
an enterprise database in communication with the enterprise server, the enterprise database containing a listing of content available on the global communications network and corresponding topical categories of the content;
an artificial intelligence program within the enterprise server, the artificial intelligence program configured to examine requested content and to determine the nature of the requested content;
a policy database containing a policy for each user that defines the user's privileges for receiving selected types of content of the global communications network;
a report generation module local to the enterprise server, the report generation module configured to generate and transmit reports to the supervisor both automatically and upon request; and
the enterprise server configured to receive the notice of the user requests, and in response, to consult the enterprise database to determine the type of the content requested by the user and to utilize the artificial intelligence program if the content is not listed by the enterprise database, compare the type of the content requested by the user against a policy containing the user's privileges for viewing global communications network content, notify the client monitoring module whether to allow the content requested by the user to be received by the user, and to compile information regarding the requests made by a user for content available on a global communications network and to periodically transmit the information to a supervisor module.

17. The system of claim 15, further comprising a content caching module local to the client monitoring module, the content caching module configured to record the topical categories of previously requested content, and wherein the client monitoring module is further configured to consult the caching module to determine if content requested by a user is present within the content caching module, and if the content is present, dispense with forwarding notice of the user requests to the enterprise server.

18. A method for remotely monitoring client activities over a global communications network, the method comprising:
providing an enterprise server configured to receive notice of requests made by a user for content available on a global communications network; and
intercepting a user request for the transmission of content across the global communications network, forwarding notice of the request to the enterprise, and selectively allowing the requested content to be received by the user.

19. The method of claim 18, further comprising determining at the enterprise server the type of the content requested by the user.

20. The method of claim 19, further comprising notifying the client monitoring module of the type of the content requested by the user as determined by the enterprise server.

21. The method of claim 19, further comprising comparing at the enterprise server the type of the content requested by the user against a policy containing the user's privileges for viewing global communications network content.

22. The method of claim 19, further comprising notifying the client monitoring module from the enterprise server whether to allow the content requested by the user to be received by the user.

23. The method of claim 19, further comprising referencing an enterprise database in determining the type of the content requested by the user.

24. The method of claim 23, further comprising using an artificial intelligence program to examine requested content and to determine the nature of the requested content when the requested content is not present in the enterprise database.

25. The system of claim 18, wherein the enterprise server is further configured to compile information regarding the requests made by a user for content available on a global communications network and to periodically transmit the information to a supervisor module.

26. The method of claim 18, further comprising providing a policy database within the enterprise server, the policy database containing a policy for each user that defines the user's privileges for receiving selected types of content of the global communications network.

27. The method of claim 18, further comprising providing a content caching module local to the client monitoring module, the content caching module configured to record the topical categories of previously requested content, and further comprising consulting the caching module to determine if content requested by a user is present within the content caching module, and if the content is present, dispense with forwarding notice of the user requests to the enterprise server.

28. The method of claim 23, further comprising initially populating the enterprise database with data from a commercial categorization server.
